(19) United States
(12) Patent Application Publication
(10) Pub. No.: US 2015/0161890 A1
(43) Pub. Date: Jun. 11, 2015

(54) METHODS FOR IDENTIFYING PARKING SPOTS

(71) Applicant: GM GLOBAL TECHNOLOGY OPERATIONS LLC, Detroit, MI (US)

(72) Inventor: Fred W. Huntzicker, Ann Arbor, MI (US)

(73) Assignee: GM GLOBAL TECHNOLOGY OPERATIONS LLC, Detroit, MI (US)

(21) Appl. No.: 14/098,461

(22) Filed: Dec. 5, 2013

(51) Int. Cl. G08G 1/14

(52) U.S. Cl. CPC G08G 1/141

(57) ABSTRACT

In an example of a method for identifying parking spots, an update signal is recognized by an in-vehicle microprocessor of the participating vehicle running computer readable instructions stored on a non-transitory, computer readable medium. The updated signal includes an update of a status of a participating vehicle. The status is selected from the group consisting of a lock status, a trunk status, a door status, an ignition/power status, a transmission status, an odometer status, or combinations thereof. The in-vehicle microprocessor also recognizes a last activated time associated with the status. The in-vehicle microprocessor identifies a maximum probability of the participating vehicle leaving a parking space within a determined time period based on the status and the last activated time. The participating vehicle transmits a message including the maximum probability and geographic coordinates of the parking space.

### TECHNICAL FIELD

The present disclosure relates generally to methods for identifying parking spots.

### BACKGROUND

Trying to find a parking space can be a frustrating experience for a vehicle driver. In rural areas, parking lots, structures, etc. may not be abundant, and in urban areas, the number of vehicles can make it difficult to find an open space. Vehicle drivers often travel on the same street(s) multiple times around a destination in order to find a parking spot. Continuous circling without success often results in wasted time and building frustration.

### SUMMARY

In an example of a method for identifying parking spots, an update signal is recognized by an in-vehicle microprocessor of the participating vehicle running computer readable instructions stored on a non-transitory, computer readable medium. The update signal includes an update of a status of a participating vehicle. The in-vehicle microprocessor also recognizes a last activated time associated with the status. The status is selected from the group consisting of a lock status, a trunk status, a door status, an ignition/power status, a transmission status, an odometer status, or combinations thereof. The in-vehicle microprocessor identifies a maximum probability of the participating vehicle leaving a parking space within a determined time period based on the status and the last activated time. The participating vehicle transmits a message including the maximum probability and geographic coordinates of the parking space.

Other examples of the method involve utilizing the maximum probability and the geographic coordinates to assist other vehicles in finding an open parking space/spot.

### BRIEF DESCRIPTION OF THE DRAWINGS

Features and advantages of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a schematic view of an example of a system for identifying parking spots;

FIG. 2 is a schematic flow diagram illustrating an example of a method for identifying a parking spot; and

FIG. 3 is a schematic illustration of how a central server may respond to respective requests for a parking spot from two different vehicles.

### DETAILED DESCRIPTION

Example(s) of the system and method disclosed herein enable a user of a vehicle to receive assistance in finding a parking spot through a parking spot identification service. The service may be operated through a server that participating vehicles communicate with, or it may be operated through vehicle-to-vehicle communication between participating vehicles. In the examples disclosed herein, vehicle data from a participating vehicle (e.g., a parked vehicle) is utilized to calculate a maximum probability that that vehicle is or will be vacating a parking spot soon. As such, the examples disclosed herein infer probability of upcoming openings or actual openings, in some instances without using parking lot detection infrastructure. The probability information may be transmitted to other participating vehicles that have requested assistance in finding a parking spot or are listening to in-coming vehicle communications.

It is to be understood that, as used herein, the term “user” includes a vehicle owner or another authorized driver of the vehicle. In some examples, the user is a customer of a telematics unit service provider that operates the parking spot identification service disclosed herein.

The term “communication” is to be construed to include all forms of communication, including direct and indirect communication. Indirect communication may include communication between two components with additional component(s) located therebetween.

Further, the terms “connect/connected/connection” and/or the like are broadly defined herein to encompass a variety of divergent connected arrangements and assembly techniques. These arrangements and techniques include, but are not limited to (1) the direct communication between one component and another component with no intervening components therebetween; and (2) the communication of one component and another component with one or more components therebetween, provided that the one component being “connected to” the other component is somehow in operative communication with the other component (notwithstanding the presence of one or more additional components therebetween).

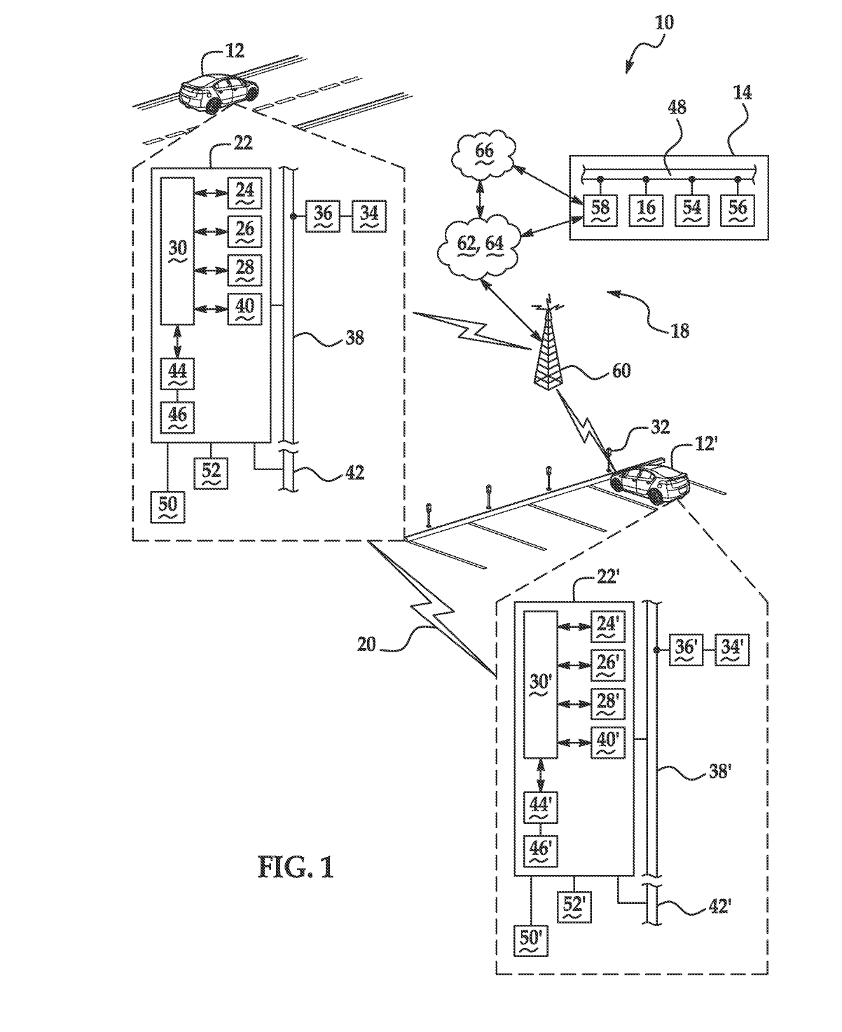

FIG. 1 depicts an example of a system 10 for identifying a parking spot. The system 10 may include participating vehicles 12, 12′ and a parking spot identification service provider 14. In an example of the system 10, the vehicle 12′ is a participating vehicle that i) recognizes a change in its status, ii) calculates, in response to the change, the maximum probability that it is or will be vacating a parking spot, and iii) transmits the maximum probability and its geographic coordinates to either a server 16 of the parking spot identification service provider 14 or a listening vehicle 12. In another example of the system 10, the vehicle 12′ is a participating vehicle that i) recognizes a change in its status, and ii) transmits an update signal and its geographic coordinates to either the server 16 of the parking spot identification service provider 14 or the listening vehicle 12. In this particular example, the server 16 or the listening vehicle 12 then calculates the maximum probability that the vehicle 12′ is or will be vacating a parking spot. It is to be understood that when the server 16 receives or calculates the maximum probability, the server 16 can then use this information to assist other participating vehicles, e.g., vehicle 12, in finding a parking spot. Throughout the discussion of FIG. 1, while vehicle 12 is the requesting or listening vehicle and vehicle 12′ is the parked vehicle, it is to be understood that both vehicle 12, 12′ may be capable of performing the functions of the other vehicle 12′, 12.

The participating vehicles 12, 12′ may be any vehicle, such as a car, motorcycle, truck, or recreational vehicle (RV), that is equipped with suitable hardware and computer readable instructions/code that enable it to communicate (e.g., transmit and/or receive voice and data communications) over a carrier/communication system 18 and/or using Dedicated Short Range Communications (DSRC) 20.

Some vehicle communications (e.g., between the vehicle 12 or 12′ and server 16) utilize radio transmissions to establish a voice channel with the carrier/communication system 18 such that both voice and data transmissions may be sent and received over the voice channel. In some instances, vehicle communications are enabled through a telematics unit 22, 22′ via a cellular chipset/component 24, 24′ for voice communications and a wireless modem 26, 26′ for data transmission. In order to enable successful data transmission over the voice channel, wireless modem 26, 26′ applies some type of encoding or modulation to convert the digital data so that it can communicate through a vocoder or speech codec incorporated in the cellular chipset/component 24, 24′. It is to be understood that any suitable encoding or modulation technique that provides an acceptable data rate and bit error may be used with the examples disclosed herein.

The cellular chipset/component 24, 24′ of the telematics unit 22, 22′ may be an analog, digital, dual-mode, dual-band, multi-mode and/or multi-band cellular phone. The cellular chipset-component 24, 24′ uses one or more prescribed frequencies in standard analog and/or digital bands in the current market for cellular systems. Any suitable protocol may be used, including digital transmission technologies, such as TDMA (time division multiple access), CDMA (code division multiple access), and FDMA (frequency-division multiple access).

As mentioned above, the telematics unit 22, 22′ may also be configured with a short range wireless communication unit 28, 28′ for dedicated short-range communications (DSRC) 20. DSRC 20 is a two-way short- to- medium-range wireless communications capability that permits very high data transmission between vehicles 12, 12′ that are within a predetermined geographic proximity of one another, and between the vehicle 12, 12′ and infrastructure 32, such as a parking meter, that is within a predetermined geographic proximity of the vehicle 12, 12′. The predetermined geographic proximity may depend upon the network (e.g., protocol level, contention mechanism, etc.) used for the communications. DSRC 20 enables one vehicle 12′ to transmit either update signals or messages to the listening vehicle 12 within the predetermined geographic proximity. DSRC 20 also enables the vehicle 12, 12′ to receive information from infrastructure 32 within the predetermined geographic proximity. This information may include, for example, time remaining on a parking meter, etc. The short range wireless communication unit 28, 28′ may also be equipped for other short range wireless communication technologies, such as BLUETOOTH®, or Wi-Fi™. In these instances, the cellular chipset/component 24, 24′ may operate in conjunction with the short range wireless communication unit short range wireless communication unit 28, 28′.

In the examples disclosed herein, the participating vehicles 12, 12′ are capable of recognizing an update signal indicating a change in the status of one or more of their respective components, such as the locks, trunk, door, ignition/power, transmission, odometer, or combinations thereof. In the example shown in FIG. 1, the parked vehicle 12′ is monitoring for the update signal(s). In some examples, the participating vehicles 12, 12′ are triggered to monitor for and recognize their own update signal(s) whenever the ignition/power is turned off. In other examples, the in-vehicle processor 30, 30′ may be programmed to recognize that the associated vehicle 12, 12′ is within a predefined region (e.g., a parking lot, a parking structure, an urban area, etc.) and trigger monitoring for update signals. In these examples, the telematics unit 22, 22′ may utilize its location detection unit 40, 40′ to detail the vehicle's location with respect to the predefined region (which may be stored in a memory 44, 44′). In still other examples, an authorized vehicle user may set up a private exclusion zone (e.g., away from the garage address of the vehicle), and when the vehicle 12, 12′ is located within this zone, the in-vehicle processor 30, 30′ will not monitor or receive the update signal(s).

The status changes are detected by various sensors 34, 34′ within the vehicle 12, 12′. Examples of these sensors 34, 34′ include a door open/close switch, a trunk open/close switch, a transmission position switch/sensor (tps), odometer reading sensors (e.g., wheel speed sensors, transmission output sensors, etc.), an ignition/power on/off sensor, or any other suitable sensors that detect the desired change in vehicle component status.

While not shown in FIG. 1, the vehicles 12, 12′ may also include other vehicle sensors. Examples of these other vehicle sensors may include crash and/or collision sensors. The crash sensors provide information to the telematics unit 22, 22′ via a crash and/or collision detection sensor interface regarding the severity of a vehicle collision, such as the angle of impact and the amount of force sustained. Still further examples of other vehicle sensors include key detecting sensors, gyroscopes, accelerometers, magnetometers, emission detection and/or control sensors, lane departure sensors (e.g., video sensors, laser sensors, infrared sensors, etc.), speed sensors, following distance sensors (e.g., radar sensors, video sensors, infrared sensors, ultrasonic sensors, etc.), braking activity sensors, environmental detection sensors, and/or the like.

Upon detecting the status change, the sensor 34, 34′ transmits the update signal (which includes the status change) to an in-vehicle micro-processor 30, 30′. As will be discussed further hereinbelow, the in-vehicle micro-processor 30, 30′ is capable of recognizing the update signal and responding thereto.

The update signal(s) are transmitted from the sensors 34, 34′ through a sensor interface module 36, 36′ (to which the sensor 34, 34′ is operatively connected). Examples of the sensor interface modules 36, 36′ include a powertrain control module, a climate control module, a body control module, and/or the like.

From the sensor interface module 36, 36′, the update signals are transmitted to a vehicle bus system 38, 38′. The vehicle bus system 38, 38′ may utilize a variety of networking protocols, such as a controller area network (CAN), a media oriented system transfer (MOST), a local interconnection network (LIN), an Ethernet or TCP/IP, and other appropriate connections such as those that conform with known ISO, SAE, and IEEE standards and specifications, to name a few. The vehicle bus system 38, 38′ enables the respective vehicle 12, 12′ to send signals (i.e., real-time bus messages, such as the previously mentioned update signal) from the sensors 34, 34′ to the in-vehicle microprocessor 30, 30′ of the telematics unit 22, 22′. The vehicle bus system 38, 38′ also enables the respective vehicle 12, 12′ to send signals from the telematics unit 22, 22′ to various units of equipment and systems both outside the respective vehicle 12, 12′ and within the respective vehicle 12, 12′ to perform or initiate various functions, such as unlocking a door, executing personal comfort settings, and/or the like. The vehicle bus systems 38, 38′ also enable the respective vehicle 12, 12′ to receive signals at the telematics unit 22, 22′ from various units of equipment and systems both outside the respective vehicle 12, 12′ and within the respective vehicle 12, 12′. Digital information may be received at telematics units 22, 22′ via the vehicle bus system 38, 38′.

The vehicle bus system 38, 38′ transmits the update signal(s) to the in-vehicle microprocessor 30, 30′. In addition to being able to receive the update signal and recognize the status change, the in-vehicle microprocessor 30, 30′ may also be able to recognize and associate a time-stamp with the update signal, thereby indicating the time at which the status change takes place. For example, the in-vehicle microprocessor 30, 30′ is capable of receiving the signal indicating that the vehicle door has been opened, and is capable of generating a time-stamp indicating the time at which the vehicle door was opened.

In the example shown in FIG. 1, the in-vehicle microprocessor 30, 30′ is part of the telematics unit 22, 22′. The in-vehicle telematics unit 22, 22′ is an on-board vehicle dedicated communications, and, in some instances, entertainment device. The in-vehicle telematics unit 22, 22′ includes hardware components (e.g., microprocessor 30, 30′) that are capable of running computer readable instructions/code, which are embodied on non-transitory, tangible computer readable media. In any of the examples disclosed herein, the computer readable media may include any one of many physical media such as, for example, electronic, magnetic, optical, electromagnetic, or semiconductor media. More specific examples of suitable computer readable media include hard drives, a random access memory (RAM), a read-only memory (ROM), an erasable programmable read-only memory (EPROM), or a portable CD, DVD, or flash drive.

The telematics unit 22, 22′ may provide a variety of services to a vehicle operator, both individually and through its communication with the other vehicle 12′, 12 and/or with the parking spot identification service provider 14. Several examples of these services include, but are not limited to: identifying (or assisting in identifying) parking spots, turn-by-turn directions and other navigation-related services provided in conjunction with a location detection based chipset/component 40, 40′; airbag deployment notification and other emergency or roadside assistance-related services provided in connection with various crash and/or collision sensor interface modules and sensors located throughout the vehicle 12, 12′; and infotainment-related services where music, Web pages, movies, television programs, videogames and/or other content is downloaded by the telematics unit 22, 22′ via the vehicle bus system 38, 38′ and an audio bus system 42, 42′. The listed services are by no means an exhaustive list of all the capabilities of the telematics unit 22, 22′, but are simply an illustration of some of the services that the telematics unit 22, 22′ is capable of offering.

The in-vehicle microprocessor 30, 30′ of the telematics unit 22, 22′ is operatively coupled to one or more types of electronic memory 44, 44′, which has an in-vehicle application 46, 46′ resident thereon. The electronic memory 44, 44′ may be an encrypted memory that is configured to store computer readable instructions/code to be executed by the processor 30, 30′, data associated with the various systems of the vehicle 12, 12′ (i.e., vehicle data including status updates), vehicle operations, vehicle user preferences and/or personal information, and the like. As another example, the electronic memory 44, 44′ may also store unique identifying code(s) that can be used to establish short range wireless connections.

In some of the examples disclosed herein, upon recognizing receipt of the update signal (either the vehicle's own update signal or an update signal received from another vehicle), the in-vehicle micro-processor 30, 30′ is triggered to generate the time-stamp and to initiate the application 46, 46′. The application 46, 46′ may be downloaded (e.g., from an online application store or marketplace) and stored on the electronic memory 44, 44′. Various examples of the application 46, 46′ are disclosed herein, and each example includes computer readable instructions for performing one or more steps of the methods disclosed herein.

In an example, the application 46′, 46 includes computer readable instructions for receiving and recognizing the update signal(s) and associated time-stamp(s) from the vehicle 12′, 12, for identifying a maximum probability that the vehicle 12′, 12 will be leaving a parking space within a determined time period based on the status and time information, and for transmitting message(s) that include at least the maximum probability to the server 16 or to another vehicle 12, 12′. In another example, the application 46, 46′ includes computer readable instructions for receiving message(s) from the other vehicle(s) 12′, 12 or from the parking spot identification service provider 14, and displaying the message information within the 12, 12′. In this example, the message(s) may include a determined maximum probability that the other vehicle 12′, 12 is leaving a parking space. In still another example, the application 46′, 46 includes computer readable instructions for receiving and recognizing the update signal(s) and associated time-stamp(s) from the vehicle 12′, 12, and for transmitting the update signal(s) and associated time-stamp(s) to other vehicles 12, 12′ or to the parking spot identification service provider 14. In yet another example, the application 46, 46′ includes computer readable instructions for receiving update signal(s) and associated time-stamp(s) from another vehicle 12′, 12, and for identifying a maximum probability that the other vehicle 12′, 12 will be leaving a parking space within a determined time period based on the status and time information.

Some examples of the application 46′, 46 include combinations of the previously described computer readable instructions. For example, the application 46 stored in the vehicle 12 may include the computer readable instructions for receiving and recognizing its own update signal(s) and time-stamp(s), for identifying the maximum probability that it will be leaving a parking space, and for transmitting the message(s) to another vehicle 12′ or the parking spot identification service provider 14, and may also include the computer readable instructions for receiving message(s) (from other vehicle(s) 12′ or the provider 14) which include a maximum probability that the other vehicle(s) 12′ will be leaving a parking space, and for displaying the received maximum probability within the vehicle 12. In this particular example then, the vehicle 12 is capable of determining the maximum probability that it will be leaving a parking space and is also capable of receiving the maximum probability that another vehicle 12′ will be leaving a parking space.

When the application 46, 46′ includes computer readable instructions for identifying the maximum probability that the vehicle 12, 12′ itself will be leaving a parking space or for identifying the maximum probability that another vehicle 12′, 12 will be leaving a parking space, the application 46, 46′ is programmed to utilize, respectively, the update signal from the vehicle 12, 12′ itself or the update signal received from the other vehicle 12′, 12. When determining the maximum probability, the in-vehicle micro-processor 30, 30′ running the computer readable instructions utilizes any status and time information that is transmitted. If a single update status and time is received, the maximum probability can be based on that single update status and time. Alternatively, when a single update status and time is received, the in-vehicle micro-processor 30, 30′ may also be programmed to request the last activated time for any of the other statuses that were not included in the received update signal. For example, if the update signal that triggers the maximum probability determination is the vehicle door being opened at 1:00 pm (without any other updated signals being received), then in-vehicle micro-processor 30, 30′ can retrieve or request data from the electronic memory 44, 44′ for the most recent ignition/power change, transmission change, lock change, etc. In these instances, the maximum probability can be based on multiple update statuses and associated times. In another example, multiple update signals may be received within seconds or minutes of one another (e.g., trunk open at t₁, door open at t₂, ignition on at t₃, transmission from park to drive at t₄) and the maximum probability can be based on all of the update statuses and associated times. If a maximum probability is determined based on a single received status and time, the probability can be updated when a more recent status and time is received.

In each of the examples disclosed herein, the maximum probability represents the highest probability, based upon the status(es) and time(s) received or received and retrieved, that the vehicle 12′ or 12 will be vacating a parking spot/space within some determined time period. In an example, each status has a function that represents the probability of the vehicle 12′ or 12 leaving the parking spot/space within a given time that is based on the time associated with the status. For example, for a received update signal that includes a door open status and an associated time, the function may be Pₘₐₓ(dooropen(last activated time)) that would indicate the probability of a parking space being vacated within a given time from the time of the door being opened. When multiple statuses and times are received, the respective function for each status may be used and the corresponding probabilities may be summed. In these example, weighting may be inherent in the probability function, and thus additional weighting is not utilized. For another example involving multiple statuses and associated times, a single function may be used for all of the statuses, e.g., Pₘₐₓ(\vec{A}, \vec{B}, \vec{C}, . . . n), where each probability vector represents one status and its associated time and n represents the maximum number of statuses and times utilized. In many instances, the most recent status received will represent the most probable condition as an indicator that the vehicle 12′, 12 will move, and so other statuses may be weighted lower in the function to reflect this. In an example, an ignition on status time-stamped 1 minute ago may be weighted higher in the function than a trunk open status time-stamped 10 minutes ago (which may have been received in the form of an update signal or retrieved from the memory 44, 44′), and the maximum probability may be determined using the two probabilities. In another example, an ignition on status for the vehicle time-stamped 1 minute ago may be a highly weighted indicator until a subsequent status is received 5 minutes after the ignition on status indicating that the vehicle door was just opened. In this example, upon receipt of the door open status, the maximum probability may be determined again, where the function automatically accounts for the adjusted lower weight of the ignition on status and the higher weighted door open status.

In any of the examples disclosed herein, the function may be a mathematical expression that models the general vehicle population (for a given status or combination of statuses) or a lookup table representing an approximation of the general vehicle population (for a given status or combination of statuses). As two examples, the function may be the probability density function (pdf) or the cumulative probability density function (cdf). In some instances, the pdf may provide more accurate information. The function may be empirically determined through a study with sample data (e.g., from a selected number of vehicles within the general vehicle population that participate in the study), or from data obtained from other participating vehicles 12, 12′ (which are part of the general vehicle population). As such, the function and the resulting probability may vary by region, time of year, type of parking space (e.g., street parking versus parking lot), etc. For example, in winter months in areas where snow and ice is prevalent, the function and resulting probability may reflect the fact that ignition on events are often followed by a relatively long time lapse before a transmission change due, for example, to remote starts and warming up of the vehicle 12′, 12. In these same areas during the summer months, the function and resulting probability may reflect the fact that ignition on events are often followed by a shorter time lapse before a transmission change than is observed in the winter months.

Using the update signal(s) and time(s) and the function, the maximum probability for any given status(s) and time(s) may be determined by the application 46, 46′.

In some examples, the maximum probability is determined based on the vehicle update signal(s) alone. In other examples, the application 46, 46′ may receive parking space vacancy information from infrastructure 32 through vehicle-to-infrastructure communications using DSRC 20. The parking space vacancy information may include parking meter data, such as expired meters, time remaining on a meter, etc. This information may be used in conjunction with the update signal information to enhance the accuracy of the maximum probability. As an example, the infrastructure data may be used in conjunction with the vehicle status update(s) and time(s) to develop a joint probability. The function used in this case models or represents the general vehicle population's behavior associated with the status(es) change and the particular infrastructure date. For example, the maximum probability for the combination of a park to drive status change and data that there is less than 10 minutes remaining on a meter may be that 98% of vehicles move within 5 minutes. Alternatively, the infrastructure data may be used as a check to determine whether the maximum probability based on the status change has or has not expired. For example, if an ignition on status change update signal is received at 1:05 pm, but infrastructure data at 1:08 pm indicates that the meter expiration time has been extended by 30 minutes, the probability that the parking space will be vacated may be cancelled since it is unlikely that the vehicle 12′ would be moved if additional meter time were purchased. Likewise, if the meter time expired at 1:08 pm, this would be an indication that maximum probability associated with the ignition on status change is still valid.

When the application 46, 46′ resident on the in-vehicle memory 44, 44′ performs the maximum probability calculation, the application 46, 46′ also includes computer readable instructions to generate a message that includes the maximum probability and then-current geographic coordinates of the vehicle 12, 12′, which correspond to the geographic coordinates of the parking space.

In other examples of the method, the vehicle 12′, 12 sends the update signal to the server 16 or to another vehicle 12, 12′ for determining the maximum probability that the 12′, 12 will be vacating a parking space. In these instances, the update signal may include the status, the time associated with the status, and the then-current location of the vehicle 12′, 12 transmitting the update signal.

In any of the examples disclosed herein, the then-current location of the vehicle 12′, 12 (e.g., geographic coordinates) may be retrieved by the location detection chipset/component (i.e., unit) 40′, 40 of the vehicle 12′, 12. The location detection chipset/component (i.e., unit) 40′, 40 may include a GPS receiver, a radio triangulation system, a dead reckoning position system, and/or combinations thereof. In particular, a GPS receiver provides accurate time and latitude and longitude coordinates of the vehicle 12′, 12 responsive to a GPS broadcast signal received from a GPS satellite constellation (not shown). The location detection chipset/component 40′, 40 may also include, for example, Glonass (i.e., global navigation satellite system), Sbas (i.e., satellite-based augmentation systems), or a D-GPS (differential global positioning system). The location detection chipset/component 40′, 40 may or may not be part of a navigation unit.

In some examples, the vehicle 12′, 12 may also be in communication with the infrastructure 32, which may include a payment system for a parking lot or structure. This communication may enable the vehicle 12′, 12 to be aware of the parking spot location data directly from the infrastructure 32. As such, the infrastructure 32 may hard-code the position data.

In an example, the message or the update signal and associated time may be transmitted as a packet data message from the telematics unit 22′, 22 to the server 16 of the parking spot identification service provider 14 using the vehicle bus system 38′, 38, a bus system 48 of the service provider 14, and the carrier/communication system 18. In another example, the message or update signal and associated time may be broadcast from the vehicle 12′, 12 using the vehicle bus system 38′, 38 and DSRC 20. The broadcast message may be received by any participating listening vehicle 12, 12′ that is within the DSRC proximity of the vehicle 12′, 12 broadcasting the message.

While not shown, it is to be understood that in the examples disclosed herein, the telematics units 22, 22′ of the participating vehicles 12, 12′ may also include a real-time clock (RTC), a short-range wireless antenna, and/or a dual mode antenna. The real-time clock (RTC) is capable of providing accurate date and time information to the telematics unit 22, 22′ hardware and software components that may require and/or request date and time information. As such, the real-time clock in conjunction with the microprocessor 30, 30′ may provide the time-stamp of the update signal. Generally, the short-range wireless antenna services the short-range wireless communication unit 28, 28′ and the dual mode antenna services the location detection chipset/component 40, 40′ and the cellular chipset/component 24, 24′. It is to be further understood that the in-vehicle telematics units 22, 22′ may be implemented without one or more of the above listed components (e.g., the real-time clock), and that the in-vehicle telematics units 22, 22′ may also include additional components and functionality as desired for a particular end use.

In addition to being able to send message(s) and/or update signal(s) and associated time(s), the vehicles 12, 12′ may also be capable of receiving parking spot information (including the maximum probability information calculated by the server 16 or by another vehicle 12′, 12), navigation route information, or other information for transmission to occupants within the vehicle 12, 12′. As such, the vehicles 12, 12′ may include speaker(s) 50, 50′ and/or a display 52, 52′ to relaying the information to the in-vehicle occupants.

The speaker(s) 50 may be part of a speaker system of the telematics units 22, 22′, or they may be the vehicle speaker(s). The speaker(s) 50 may also be operatively connected to an audio component that receives analog information, rendering it as sound, via the audio bus system 42, 42′. The audio component may provide AM and FM radio, high-definition radio, satellite radio, CD, DVD, multimedia, and other like functionality, in conjunction with the controller/processor 30, 30′ of the telematics units 22, 22′.

The display 52, 52′ may be operatively directly connected to or in communication with the telematics units 22, 22′. In an example, the display 52, 52′ may be used to display the maximum probability and the geographic coordinates of a parking space which is received at the vehicle 12, 12′ from another vehicle 12′, 12 or from the service provider 14. Examples of the display 52, 52′ include a VFD (Vacuum Fluorescent Display), an LED (Light Emitting Diode) display, a driver information center display, a radio display, an arbitrary text device, a heads-up display (HUD), an LCD (Liquid Crystal Diode) display, and/or the like. In an example, the display 52, 52′ is a full-color touch screen display.

As previously mentioned, some examples of the method disclosed herein involve the parking spot identification service provider 14. The parking spot identification service provider 14 may be its own entity or may be part of an in-vehicle telematics unit service provider that offers a variety of telematics related services (e.g., communication services, navigation services, emergency services, etc.) to the participating vehicles 12, 12′.

The parking spot identification service provider 14 includes a computer network in order to store and retrieve participating vehicle and/or customer information, to accept customer payments for the parking spot identification service, and/or to perform any other computer-related tasks associated with the parking spot identification service. As shown in FIG. 1, the computer network of the parking spot identification service provider 14 may include computer equipment, such as server(s) 16, processor(s) 54, database(s) 56 (e.g., for receiving and storing vehicle and customer data/information and parking spot information), communication module(s) 58, etc. that are operatively connected to a bus 48 (similar to bus 38, 38′, discussed above).

The processor 54 may be a controller, a host processor, and/or a processor working in conjunction with a central processing unit (CPU) performing the function of a general-purpose processor. The processor 54 includes hardware components that are capable of running computer readable instructions/code, which are embodied on non-transitory, tangible computer readable media.

The receipt and transmission of message(s) to and from the service provider 14 is accomplished through the communications module 58. In an example, the communications module 58 includes suitable communications equipment, such as switches, switchboards, etc., modems, TCP/IP supporting equipment, and/or the like, to enable the server 16 to establish a communication with, for example, the vehicles 12, 12′. In an example, the communications module 58 may receive a request for parking spot information from the vehicle bus 38 of the vehicle 12 and may receive update signal(s) from the vehicle bus 38′ of the parked vehicle 12′ indicating that the parked vehicle 12′ may soon be vacating a parking spot.

The server 16 is a system of computer hardware (which may include the processor 54) and software (i.e., computer readable code/instructions). In an example, the hardware of the server 16 runs the computer readable instructions that enable the server 16 to receive the message(s) from participating vehicle(s) 12′, to receive the requests from other participating vehicle(s) 12, and to transmit probability and geographic information contained within the message(s) to the requesting, participating vehicle(s) 12. In this example, the vehicle 12′ calculates its own maximum probability, but the server 16 uses the information to assist other vehicles 12. In another example, the hardware of the server 16 runs the computer readable instructions that enable the server 16 to receive the update signal(s) and geographic information from participating vehicle(s) 12′ and to calculate the maximum probability from the update signal(s). In this example, the server 16 determines the maximum probability and uses the information to assist other vehicles 12. In still another example, the hardware of the server 16 runs the computer readable instructions that enable the server 16 to set or identify a geographic boundary around the current location of the requesting vehicle 12, and also to provide navigation services to the requesting vehicle 12.

At the server 16, the maximum probability may be determined in the same manner and using similar computer readable instructions and function(s) as previously described for the application 46, 46′ in the vehicle 12, 12′ that determines the maximum probability.

The server 16 may receive maximum probabilities and geographic coordinates from any or all of the participating vehicles 12′, 12 and/or may determine maximum probabilities and geographic coordinates for any or all of the participating vehicles 12′, 12. To service requesting vehicles 12, 12′, the maximum probability and geographic coordinate information that is received or determined by the server 16 may be temporarily stored in the database(s) 56 of the parking spot identification service provider 14. The time for temporary storage may depend upon the maximum probability. For example, if the received or determined probability is that 90% of vehicles having similar status updates vacate their parking spots within 10 minutes, the information may be stored for 10 minutes. If a request for parking space information within proximity of the stored geographic coordinates is received at the server 16 within that time frame, the information will be utilized to assist the requesting vehicle 12 in finding a parking space. After the 10 minutes, the information will be deleted from the database 56. Temporary storage of the maximum probability and geographic coordinate information may be desirable because such information may become stale within a relatively short period of time.

The server 16 is capable of recognizing the geographic coordinates or other geographic information that is transmitted from a parked vehicle 12′ in the form of the update signal (which does not include the maximum probability) or the message (which includes the maximum probability), or from the requesting vehicle 12 in the form of a parking spot request.

When the geographic information is received from a parked vehicle 12′ in an update signal, the server 16 runs computer readable instructions that can extract the geographic information, determine the maximum probability, and categorize and temporarily store the maximum probability based on the geographic information. When the geographic information is received from a parked vehicle 12′ in a message, the server 16 runs computer readable instructions that can extract the geographic information and the maximum probability, and then categorize and temporarily store the maximum probability based on the geographic information. In each of these examples, the temporarily stored information may be retrieved when the database 56 is queried, for example, using a geographic boundary as the search parameters. For example, any maximum probability whose corresponding geographic information resides with the geographic boundary will be retrieved from the database 56. The retrieved information may be used to assist a requesting vehicle 12 that is located within the geographic boundary or is headed to a destination located within the geographic boundary in finding a parking space. As such, categorizing the maximum probabilities received at or determined by the server 16 may assist in narrowing the number of probable parking spaces for requesting vehicles 12.

When the geographic information is received in a parking spot request from the vehicle 12, it may or may not be accompanied by a navigation request. In an example, when the requesting vehicle 12 asks for parking spot assistance without a navigation route request, the server 16 runs computer readable instructions that can extract the geographic information from the request to determine the requesting vehicle's current location, set a geographic boundary around the vehicle's current location, and identify probable parking space(s) within the geographic boundary based on the recently received or stored maximum probabilities of other vehicles 12′.

In another example, the requesting vehicle 12 asks for parking spot assistance with a navigation route request. In this example, the server 16 runs computer readable instructions that generate the requested route, sets a geographic boundary around the destination, identifies an estimated time at which the requesting vehicle 12 will arrive at the destination, and then identifies probable parking space(s) within the geographic boundary using the recently received or stored maximum probabilities of other vehicles 12′. In this example, the maximum probabilities of the other vehicles 12′ may be determined as the vehicle 12 approaches the geographic boundary around the destination so that the maximum probability data actually used to identify probable parking spots is more recent than when the navigation route was initially requested. In this example, the server 16 may monitor the vehicle's location to determine when it has entered the geographic boundary around the destination. In other examples, the server 16 may adjust the navigation route based on the maximum probability of finding a parking space. In these examples, the path transmitted to the vehicle 12 may not lead to the original destination, but will lead to the location of the parking spot(s) with the highest probability. In these examples, the server 16 would utilize the originally set geographic boundary to locate an area around the destination with the highest joint probability (i.e., two or more spots likely becoming available). As area around the two or more spots may be set as the destination (as opposed to the actual input destination), and the updated navigation route may be transmitted to the vehicle 12 to direct the vehicle 12 to the probable parking spots. The server 16 would also reset a tighter geographic boundary around the two or more spots. Using the reset geographic boundary, the server 16 would determine an updated highest probability or joint probability for the two or more spots within the reset geographic boundary. The server 16 may continue to re-route the vehicle 12 to the area or spot(s) with the highest probability, and may continue to update the highest probability or joint probability until the vehicle 12 finds a parking spot or the navigation route or parking spot request is cancelled. When re-routing the vehicle 12, the server 16 may also take into account the shortest travel time for the vehicle 12.

The server 16 may identify a single probable parking spot for the requesting vehicle 12 or may identify multiple probable parking spots for the requesting vehicle 12. The number of probable spots will depend upon the amount of information received from other vehicles 12′ at and around the time of the request.

The server 16 may also include and run computer readable instructions for mapping the probabilities (e.g., green=high probability, yellow=medium probability, red=low probability) for a requesting vehicle 12. This may be desirable when the vehicle 12 is in or headed to a parking lot or structure where multiple spots may be or may be coming available.

The server 16 may respond to parking spot requests by determining the location or destination location of the requesting vehicle 12, and then i) retrieving (from the database 56) stored maximum probabilities of other vehicles 12′ at or near the vehicle 12 location or destination location, or ii) determining, in real-time, maximum probabilities of other vehicles 12′ (who have recently sent update signals to the server 16) that will likely be vacating parking spots at or near the vehicle 12 location or the destination location. The probable parking space(s) (i.e., the geographic coordinates and the associated maximum probability) will be transmitted from the server 16 to the requesting vehicle 12 using the communication module 58, the bus 48, the communication system 18, and the vehicle's bus 38.

It is to be appreciated that parking spot identification service provider 14 may be any central or remote facility, manned or unmanned, mobile or fixed, to or from which it is desirable to exchange voice and data communications. As such, the server provider 14 may include live and/or automated advisors (not shown).

The parking spot identification service provider 14 shown in FIG. 1 may also be virtualized and configured in a Cloud Computer, that is, in an Internet-based computing environment. For example, the computer equipment may be accessed as a Cloud platform service, or PaaS (Platform as a Service), utilizing Cloud infrastructure rather than hosting computer equipment at a physical building. The database 46 and server 16 may also be virtualized as a Cloud resource. The Cloud infrastructure, known as IaaS (Infrastructure as a Service), typically utilizes a platform virtualization environment as a service, which may include components such as the processor 54, database 56, server 16, communications module 58, and other computer equipment. Parking spot identification requests may be acted upon by the automated advisor, which may be configured as a service present in the Cloud.

In the examples in which the server 16 is utilized, a request is sent from an occupant of the requesting vehicle 12 to the server 16 in order to initiate the process for finding a parking spot. In server-less examples in which one vehicle 12′ broadcasts its message or its update signals, no request is used. Rather, the parked participating vehicle 12′ will broadcast the information and the listening vehicle 12 will receive the broadcasted information when located within the network determined proximity for vehicle-to-vehicle DSRC 20.

In the vehicle-to-vehicle examples, either of the vehicles 12, 12′ may determine the maximum probability. For example, when the vehicle 12′ broadcasts its message, which includes its already determined maximum probability and geographic information, the telematics unit 22 can receive the message and display the parking spot information to the occupant(s) of vehicle 12. For another example, when the vehicle 12′ broadcasts its update signal, which includes the status, status time, and geographic coordinates of the vehicle 12′, the telematics unit 22 can receive the update signal, determine the probability that the vehicle 12′ will be leaving a parking space, and then display the parking spot information (including the geographic coordinates and the maximum probability) to the occupant(s) of vehicle 12.

In examples in which vehicle-to-vehicle communications are utilized, the vehicle 12′ may initiate the monitoring of its update signals in accordance with the examples previously provided. Whenever update signals are received, the application 46′ may be programmed to broadcast either the message or the update signal to any vehicle(s) 12 with the DSRC 20 range.

Any vehicle 12 that is within the DSRC 20 range of the vehicle 12′ and that is listening (i.e., whose telematics unit 22 is awake, or whose transmission is in drive, etc.) will receive the broadcasted message or update signal. The application 46 within the listening vehicle 12 may be programmed to inform the in-vehicle occupant (e.g., via an audio message or a message on the display 52) that parking spot information is available, and then give the in-vehicle occupant the option of having the information presented. For example, the application 46 may present the user with a find parking inquiry, denoted by an icon or question on the display 52 or through audible inquiries, such as “would you like to initiate the parking spot assistant?” When the user selects to receive the parking spot information (i.e., a positive user input in response to the find parking inquiry), the maximum probability and geographic information may be presented. If information is available for multiple parking spots, the application 46 (in conjunction with the display 52) may present all of the information to the in-vehicle user. The application 46 within the listening vehicle 12 may alternatively be programmed to automatically present the parking spot information within the received message or the parking spot information determined from the received update signal. In this example, the user may have the option of cancelling or overriding the automatic presentation of broadcasted parking spot information.

In the system 10, at least some communications are transmitted over the wireless carrier/communication system 18. In an example, the carrier/communication system 18 is a two-way radio frequency (RF) communication system. The carrier/communication system 18 may include one or more cell towers 60. It is to be understood that the carrier/communication system 18 may also include one or more base stations and/or mobile switching centers (MSCs) 62 (e.g., for a 2G/3G network), one or more evolved Node Bs (eNodeB) and evolved packet cores (EPC) 64 (for a 4G (LTE) network), and/or one or more land networks 66. The carrier/communication system 18 may be part of a cellular radio environment or a satellite radio environment, which may include a variety of wireless network providers (which include mobile network operator(s), not shown), utilizing the same or a variety of radio access technologies. The architecture of the wireless carrier/communication system 18 may be GSM (global system for mobile telecommunications), CDMA2000, UMTS (universal mobile telecommunications system), LTE (long-term evolution), or some other available architecture.

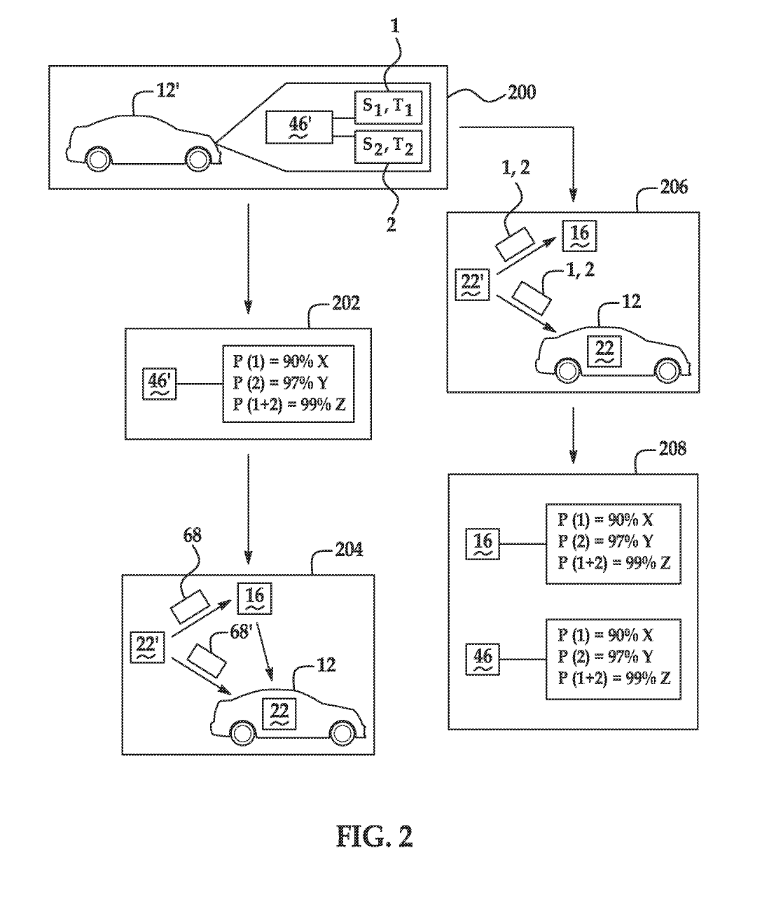

As mentioned above, the system 10 shown in FIG. 1 enables vehicles, such as parked vehicle 12′, to provide information to the server 16 or to another vehicle, such as listening vehicle 12, that can be used to assist in finding parking spots. FIG. 2 illustrates various examples of how the information can be transmitted throughout the system 10.

As shown at box 200 of FIG. 2, the application 46′ of parked vehicle 12′ recognizes a first update signal 1, including status S₁ and time T₁, and then recognizes a second update signal 2, including status S₂ and time T₂. As examples, the status S₁ may be door unlock 30 seconds prior to the current time and the status S₂ may be door open 15 seconds prior to the current time, or the status S₁ may be door open 1 minute prior to the current time and the status S₂ may be ignition on 20 second prior to the current time, or the status S₁ may be ignition on 2 minutes prior to the current time and the status S₂ may be a transmission change from park to drive 30 seconds prior to the current time. Other combinations of statuses may be received as well. Furthermore, the application 46′ may also request the last activated time of any of the other statuses not received.

At box 202 of FIG. 2, the application 46′ includes computer readable instructions (operable, for example, by the processor 30′) to calculate the maximum probability of the vehicle 12′ leaving a parking space. In the example shown in FIG. 2, the application 46′ may determine the probability based on the first update signal 1, the probability based on the second update signal 2, and the probability based on the combination of the first and second update signals 1 and 2. As illustrated, the probability function (i.e., mathematical expression or lookup table) used by the application 46′ determines that 90% of vehicles with similar S₁, T₁ vacated their parking spots within X seconds, minutes, etc., that 97% of vehicles with similar S₂, T₂ vacated their parking spots within Y seconds, minutes, etc., and that 99% of vehicles with similar S₁, T₁ and S₂, T₂ vacated their parking spots within Z seconds, minutes, etc. It is to be understood that these are examples, that that the maximum probability could be extended to all linear combinations of signals. This may enhance the value (i.e., increase the accuracy) of the maximum probability.

In this example, as shown at box 204 of FIG. 2, the application 46′ generates the message 68 to be transmitted to the server 16 or generates the message 68′ to be broadcast and received by the telematics unit 22 of a listening vehicle 12 within the DSRC range of the vehicle 12′. The application 46′ may be programmed to generate and transmit/broadcast both of the messages 68, 68′. As discussed in reference to FIG. 1, the message(s) includes the maximum probability (e.g., P(1+2)) and will also include the geographic information of the vehicle 12′ (and thus the parking spot) retrieved from the location detection unit 40, 40′. In some examples, the message(s) may include all of the determined probabilities, thereby providing the vehicle 12 with parking space options.

The information in the message 68 may be used by the server 16 to assist other vehicles (e.g., a requesting vehicle 12) in finding a parking space. The information in the message 68′ may be presented to a user within vehicle 12 to assist in finding a parking space.

Referring back to box 200, in another example, after the update signals 1, 2 are recognized by the application 46′, the telematics unit 22′ may forward the update signals 1, 2 and the geographic information of the vehicle 12′ (and thus the parking spot) to the server 16 or the telematics unit 22 of a listening vehicle 12. This transmission is shown at box 206.

As depicted at box 208, the server 16 or the application 46 of the telematics unit 22 may utilize the received update signal(s) 1, 2, to determine the probability that the vehicle 12′ will be leaving a parking spot. Similar to application 46′, the server 16 and the application 46 may be programmed to determine the maximum probability using the first update signal 1, the second update signal 2, and the combination of the first and second update signals 1 and 2 in accordance with any of the examples disclosed herein.

In one example, the determined maximum probability and associated geographic information may then be used by the server 16 to assist other vehicles (e.g., a requesting vehicle 12) in finding a parking space. In another example, the determined maximum probability and associated geographic information may then be presented to a user within the listening vehicle 12 to assist in finding a parking space.

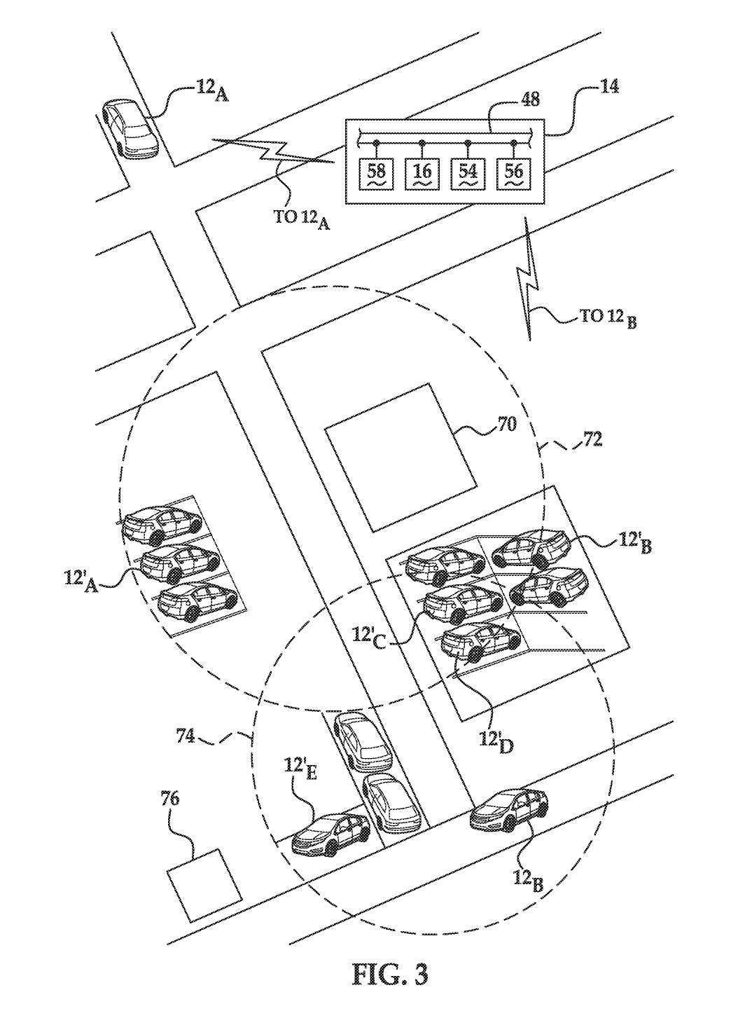

Referring now to FIG. 3, an example of the service provider 14 assisting vehicles 12_{A} and 12_{B} in finding parking spots is depicted. Vehicle 12_{A} has submitted a request to the service provider 14 for a navigation route to destination 70 and for assistance in finding a parking space within proximity of the destination 70. Vehicle 12_{B} has submitted a request to the service provider 14 for assistance in finding a parking space within proximity of the current location. The requests are received at the communications module 56 and are transmitted to the server 16 for processing and action. The user of the respective vehicles 12_{A}, 12_{B} may transmit the respective requests through a call to the service provider 14 or through the application 46 within the vehicle 12_{A}, 12_{B}.

Upon receiving the request from vehicle 12_{A}, the server 16 recognizes that a navigation route has been requested in addition to the parking space assistance request. The server 16 either requests the current location from the vehicle 12_{A} or extracts location information from the request. The server 16 then generates the requested navigation route and transmits it to the vehicle 12_{A}.

In order to assist in finding a parking spot once the vehicle 12_{A} arrives at or near the destination 70, the server 16 will estimate a time at which the vehicle 12_{A} will arrive at the destination 70. The use of the estimated time will be discussed below.

The server 16 will also identify a geographic boundary 72 around the destination 70. The perimeter of the geographic boundary 72 will generally be within walking distance (e.g., ≦0.25 miles, ≦0.5 miles) of the destination 70. In an example, when the vehicle 12_{A} crosses the perimeter of the geographic boundary 72, the server 16 will initiate a search for a probable parking spot. When the initial geographic boundary 72 results in less than some preset threshold of probable parking spots (e.g., <2, <5, etc.), the server 16 may be programmed to expand the radius or shape of the geographic boundary 72 until the threshold number of probable parking spots is found.

In performing the search for the probable parking spot, the server 16 uses the geographic boundary 72 to query the database 54 for temporarily stored maximum probabilities of vehicles 12′ (e.g., vehicles 12′_{A}, 12′_{B}, 12′_{C}) located within the geographic boundary 72. In this example, the database 54 compares the geographic boundary 72 with the saved geographic coordinates of the vehicles 12′_{A}, 12′_{B}, 12′_{C} that had transmitted messages 68 or update signals 1, 2 to the server 16. Note that vehicles 12′_{D}, 12′_{E} are not located within the geographic boundary 72. The server 16 may also be programmed to cross-check the geographic information of any new incoming messages or update signals to see if the vehicle(s) 12′ transmitting these new messages 68 or signals 1, 2 is/are associated with a potential parking space for the vehicle 12_{A}.

After identifying potential vehicles 12′_{A}, 12′_{B}, 12′_{C} (and parking spots) based on their geographic information, the server 16 may be programmed to review the maximum probabilities and the times associated with each of the vehicles 12′_{A}, 12′_{B}, 12′_{C}. If the time associated with the maximum probabilities is within some predetermined time frame of the estimated arrival of the vehicle 12_{A}, the server 16 will send the maximum probability and geographic information of those vehicles 12′_{A}, 12′_{B}, 12′_{C} to the vehicle 12_{A}. For example, if the current time is 1:00 pm, the estimated arrival time of the vehicle 12_{A} is 1:05 pm, and the maximum probability (time-stamped 12:58 pm) of vehicle 12′_{A} is that 50% of vehicles vacated their spots within 6 minutes, the maximum probability and geographic information of vehicle 12′_{A} will be transmitted to vehicle 12_{A} as a potential parking spot. Similarly, if the maximum probability (time-stamped 12:59 pm) of vehicle 12′_{B} is that 85% of vehicles vacated their spots within 3 minutes, the maximum probability and geographic information of vehicle 12′_{B} will also be transmitted to vehicle 12_{A} as a potential parking spot. Still further, if the maximum probability (time-stamped 1:01 pm) of vehicle 12′_{C} is that 90% of vehicles vacated their spots within 5 minutes, the maximum probability and geographic information of vehicle 12′_{C} will also be transmitted to vehicle 12_{A} as a potential parking spot. Still further, if the maximum probability (time-stamped 1:01 pm) of vehicle 12′_{C} is that 90% of vehicles vacated their spots within 10 minutes, the maximum probability and geographic information of vehicle 12′_{C} may not be transmitted to vehicle 12_{A} because vehicle 12′_{C} is not likely to have vacated the parking spot when vehicle 12_{A} arrives.

While several examples have been provided as to when the server 16 will transmit the probable parking spot information to the vehicle 12_{A}, it is to be understood that the server 16 may also be programmed to transmit only the probability (as determined using pdf) of a spot that is likely to be vacant in a 1 minute period at any given time. If the probable parking spot information available to the server 16 does not fit the particular criteria, the server 16 may be programmed to not transmit the probability and geographic information, and to change the geographic boundary and/or to determine again the probability. In this example, when a maximum probability or joint probability is identified that fits the criteria, it will be transmitted to the vehicle 12_{A}.

All of the parking spot information transmitted to vehicle 12_{A} may be displayed on the in-vehicle display 52. Additional parking spot information, in addition to the maximum probability and the geographic coordinates, may also be transmitted to the vehicle 12_{A}. For example, if size, color, and shape of the probable parking spots, this information may also be transmitted and displayed.

Upon receiving the request from the vehicle 12_{B}, the server 16 recognizes that the request is for parking space assistance alone. The server 16 either requests the vehicle's current location from the vehicle 12_{B} or extracts the current location information from the request.

Since the request is for parking assistance alone (without the designation of a particular destination), the server 16 assumes the vehicle 12_{B} is within proximity of whatever the destination may be. The server 16 then identifies a geographic boundary 74 around the current location of the vehicle 12_{B} to assist in narrowing probable parking spots. When constructing the boundary 74 (or 72 in the previous example), the server 16 may consider the vehicle direction of motion and one-way streets.

In performing the search for the probable parking spot, the server 16 uses the geographic boundary 74 to query the database 54 for temporarily stored maximum probabilities of vehicles 12′ (e.g., vehicles 12′_{C}, 12′_{D}, 12′_{E}) located within the geographic boundary 74. In this example, the database 54 compares the geographic boundary 74 with the saved geographic coordinates of the vehicles 12′_{C}, 12′_{D}, 12′_{E} that had transmitted messages 68 or update signals 1, 2 to the server 16. Note that vehicles 12′_{A}, 12′_{B} are not located within the geographic boundary 74. The server 16 may also be programmed to cross-check the geographic information of any new incoming messages or update signals to see if the vehicle(s) 12′ transmitting these new messages 68 or signals 1, 2 is/are associated with a potential parking space for the vehicle 12_{B}.

After identifying potential vehicles 12′_{C}, 12′_{D}, 12′_{E} (and parking spots) based on their geographic information, the server 16 may be programmed to review the maximum probabilities and the times associated with each of the vehicles 12′_{C}, 12′_{D}, 12′_{E}. If the time associated with the maximum probabilities is within some predetermined time frame of an estimated arrival of the vehicle 12_{B} to the parking spot, the server 16 will send the maximum probability and geographic information of those vehicles 12′_{C}, 12′_{D}, 12′_{E} to the vehicle 12_{B}. In this example, the estimated arrival time may be calculated by dividing the distance (e.g., miles) between the vehicle 12_{B} and the location of the respective vehicles 12′_{C}, 12′_{D}, 12′_{E} by the speed (e.g., miles/hr).

For example, if the current time is 1:00 pm, the estimated arrival time of the vehicle 12_{B} at the location of 12′_{E} 1:01 pm, and the maximum probability (time-stamped 12:58 pm) of vehicle 12′_{E} is that 60% of vehicles vacated their spots within 3 minutes, the maximum probability and geographic information of vehicle 12′_{E} will be transmitted to vehicle 12_{B} as a potential parking spot. Similarly, if the maximum probability (time-stamped 12:59 pm) of vehicle 12′_{D} is that 50% of vehicles vacated their spots within 3 minutes, the maximum probability and geographic information of vehicle 12′_{D} will also be transmitted to vehicle 12_{B} as a potential parking spot. Still further, if the maximum probability (time-stamped 1:01 pm) of vehicle 12′_{C} is that 90% of vehicles vacated their spots within 5 minutes, the maximum probability and geographic information of vehicle 12′_{C} will most likely not be transmitted to vehicle 12_{B} because vehicle 12′_{C} is not likely to have vacated the parking spot when vehicle 12_{B} arrives.

After identifying potential vehicles 12′_{C}, 12′_{D}, 12′_{E} (and parking spots) based on their geographic information, the server 16 may also be programmed to review the direction of heading of the vehicle 12_{B} with respect to the location of the vehicles 12′_{C}, 12′_{D}, 12′_{E}. For example, if the vehicle 12_{B} can go straight to the spot of vehicle 12′_{E} with a 60% probability, or can go right toward the spots of vehicles 12′_{C}, 12′_{D} each with a 50% probability (or a joint probability P(12′_{C} & 12′_{D})=1−(1−50%)*(1−50%)=75%), then the server 16 may elect to send the parking spot information for vehicles 12′_{C}, 12′_{D} instead of for vehicle 12′_{E}. In this example, if the vehicle 12_{B} had requested a navigation route to destination 76, the route could be re-calculated using the locations of vehicles 12′_{C}, 12′_{D} (associated with the higher joint probability) as the destination instead of the location of destination 76, and this updated route could be transmitted to the vehicle 12_{B}. In other examples, if the probability is higher in the direction of heading, the server 16 may elect to send the highest probability information in the vehicle's current direction of heading.

In other examples of the method, when a message 68 or update signal 1, 2, is received at the server 16 at the same time as a request for parking spot assistance, the server 16 may be programmed to compare the geographic coordinates of the message 68 or update signal 1, 2 with the request to determine if the requesting vehicle 12 is within proximity of or is en route to an area of the parked vehicle 12′. In this example, multiple parking spot information may not be utilized if the incoming message or update signal offers a suitable probable parking spot for the requesting vehicle 12.

In the examples disclosed herein, it is to be understood that the algorithm(s) of the application 46, 46′ and/or server 16 may be updated as often or as little as may be desirable. The application software may be updated wirelessly.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

While several examples have been described in detail, it will be apparent to those skilled in the art that the disclosed examples may be modified. Therefore, the foregoing description is to be considered non-limiting.

What is claimed is:

1. A method for identifying parking spots, comprising:
recognizing i) an update signal including an update of a status of a participating vehicle and ii) a last activated time associated with the status, the status being selected from the group consisting of a lock status, a trunk status, a door status, an ignition/power status, a transmission status, an odometer status, or combinations thereof, the recognizing being accomplished by an in-vehicle microprocessor of the participating vehicle running computer readable instructions stored on a non-transitory, computer readable medium;
identifying, by the in-vehicle microprocessor, a maximum probability of the participating vehicle leaving a parking space within a determined time period based on the status and the last activated time; and
transmitting, from the participating vehicle, a message including the maximum probability and geographic coordinates of the parking space.

2. The method as defined in claim 1 wherein:
prior to the identifying step, the method further comprises retrieving, by the in-vehicle microprocessor, the last activated time for any of the statuses not included in the update signal; and
the maximum probability is further based on the retrieved last activated time for any of the statuses not included in the update signal.

3. The method as defined in claim 1 wherein:
the update signal includes respective updates for a plurality of the statuses;
the in-vehicle microprocessor recognizes an associated last activated time for each of the plurality of the statuses; and
the maximum probability is a function of all of the updates and the associated last activated times.

4. The method as defined in claim 1 wherein the identifying of the maximum probability is accomplished by executing computer readable instructions that run a mathematical expression modeling a vehicle population, or by executing computer readable instructions that query a stored lookup table for the maximum probability associated with the status and the last activated time.

5. The method as defined in claim 1 wherein the transmitting of the message includes sending a packet data message to a central server.

6. The method as defined in claim 5, further comprising:
receiving, at the central server, a request for parking spot information from a requesting vehicle;
determining that the requesting vehicle is located within a predetermined time or distance of the parking space or is en route to an area in proximity of the parking space; and
transmitting the maximum probability and geographic coordinates of the parking space to the requesting vehicle.

7. The method as defined in claim 5, further comprising receiving, at the central server, a plurality of messages from a plurality of different participating vehicles, each of the plurality of messages including a respective maximum probability of one of the different participating vehicles leaving a respective parking space within a determined time period, and respective geographic coordinates of the respective parking space.

8. The method as defined in claim 7, further comprising:
narrowing the received respective maximum probabilities using a geographic boundary and the respective geographic coordinates; and
electronically mapping the narrowed respective maximum probabilities.

9. The method as defined in claim 8, further comprising:
receiving, at the central server, a parking spot request from a requesting vehicle;
identifying, at the central server, a location of the requesting vehicle;
generating a geographic boundary around the location of the requesting vehicle;
identifying a probable parking space for the requesting vehicle from the respective parking spaces using the respective maximum probabilities, the determined time periods, the respective geographic coordinates, and the geographic boundary; and
transmitting the probable parking space to the requesting vehicle.

10. The method as defined in claim 7, further comprising:
receiving, at the central server, a navigation route request from a requesting vehicle;
identifying, at the central server, a geographic boundary around a destination of the navigation route and an estimated time at which the requesting vehicle will arrive at the destination;
identifying a probable parking space for the requesting vehicle from the respective parking spaces using the respective maximum probabilities, the determined time periods, the respective geographic coordinates, and the geographic boundary; and
transmitting the probable parking space to the requesting vehicle.

11. The method as defined in claim 1 wherein prior to recognizing the update signal, the method further includes:
recognizing that the participating vehicle is located within a predefined region; and
in response to the recognizing, initiating, by the in-vehicle microprocessor, a program having computer readable instructions that monitor for the update signal.

12. The method as defined in claim 1 wherein the transmitting of the message includes broadcasting the message, and wherein the method further comprises receiving the message at a listening vehicle.

13. A method for identifying parking spots, comprising:
receiving, at a central server or an in-vehicle microprocessor of a listening vehicle, i) an update signal from a participating vehicle including an update of a status of the participating vehicle and ii) a last activated time associated with the status, the status being selected from the group consisting of a lock status, a trunk status, a door status, an ignition/power status, a transmission status, an odometer status, or combinations thereof; and
identifying, by the central server or the in-vehicle microprocessor, a maximum probability of the participating vehicle leaving a parking space within a determined time period based on the status and the last activated time.

14. The method as defined in claim 13 wherein the identifying is accomplished by the central server, and wherein the method further comprises:
receiving, at the central server, a parking spot request from a requesting vehicle;
determining, by the central server, whether the parking spot request is associated with a navigation request; and
i) when the parking spot request is not associated with the navigation request:
recognizing a current location of the requesting vehicle;
setting a geographic boundary around the current location;
identifying, by the central server, a probable parking space for the requesting vehicle using the geographic boundary and the maximum probability; and
transmitting the probable parking space to the requesting vehicle; or
ii) when the parking spot request is associated with the navigation request:
generating, by the central server, a navigation route;
identifying a geographic boundary around a destination of the navigation route and an estimated time at which the requesting vehicle will arrive at the destination;
identifying, by the central server, a probable parking space for the requesting vehicle using the geographic boundary, the estimated time, and the maximum probability; and
transmitting the probable parking space to the requesting vehicle.

15. The method as defined in claim 13 wherein the identifying is accomplished by the central server, and wherein the method further comprises:
identifying, by the central server, geographic coordinates associated with the parking space;
categorizing the maximum probability based on the geographic coordinates; and
temporarily saving the maximum probability for a time.

16. The method as defined in claim 13 wherein the identifying is accomplished by the in-vehicle microprocessor of the listening vehicle, and wherein subsequent to receiving the update signal and prior to identifying the maximum probability, the method further comprises:
presenting, through an in-vehicle display or an in-vehicle audio system of the listening vehicle, a find parking inquiry; and
receiving, at the in-vehicle microprocessor, a positive user input in response to the find parking inquiry.

17. The method as defined in claim 13 wherein the in-vehicle microprocessor receives the message from the participating vehicle that is broadcasting the message from within a predetermined geographic proximity of the listening vehicle.

18. The method as defined in claim 13, further comprising:
recognizing, by an in-vehicle microprocessor of the participating vehicle, the update signal and the last activated time; and
broadcasting the update signal and the last activated time.

19. The method as defined in claim 13 wherein the identifying of the maximum probability is accomplished by executing computer readable instructions that run a mathematical expression modeling a vehicle population, or by executing computer readable instructions that query a stored lookup table for the maximum probability associated with the status and the last activated time.

20. A computer program for identifying parking spots, the computer program comprising computer readable instructions executable by a processor and embodied on a tangible, non-transitory computer readable medium, the computer readable instructions including:
computer readable instructions for receiving i) an update signal including an update of a status of a participating vehicle and ii) a last activated time associated with the status, the status being selected from the group consisting of a lock status, a trunk status, a door status, an ignition/power status, a transmission status, an odometer status, or combinations thereof; and
computer readable instructions for identifying a maximum probability of the participating vehicle leaving a parking space within a determined time period based on the status and the last activated time.
